(19) United States
(12) Patent Application Publication
(10) Pub. No.: US 2008/0053909 A1
(43) Pub. Date: Mar. 6, 2008

(54) Ammonia recovery process

(76) Inventor: Alexander G. Fassbender, Hudson, MA (US)

Correspondence Address: Kyla D. Cummings;Speed Law Firm, Suite 1200, 111 Center Street, Little Rock, AR, 72201, US

(21) Appl. No.: 11/517,111

(22) Filed: Sep. 6, 2006

(51) Int. Cl. C02F 1/42

(52) U.S. Cl. 210/664; 210/668; 210/681; 210/903

(57) ABSTRACT

Embodiments include a method and apparatus for cost-effective and efficient ammonia recovery from a waste stream. In some embodiments, ammonia is recovered after bicarbonate buffer removal from the waste stream via addition of an acid.

### CROSS-REFERENCE TO RELATED APPLICATIONS

This application is a continuation-in-part of co-pending U.S. patent application entitled “Nutrient Recovery Process” filed by the present inventor, Alexander G. Fassbender, on Sep. 6, 2006 with the attorney docket number of THRM/0005, which patent application is herein incorporated by reference in its entirety.

### BACKGROUND OF THE INVENTION

1. Field of the Invention

Embodiments generally relate to a nutrient recovery process. More particularly, embodiments relate to a process for recovering ammonia and other nutrients from waste streams.

2. Description of the Related Art

Waste streams contain several components which it is desirable to separate from the waste streams and from one another, either for recovery of the components for later use or to prevent release of the components or combinations of the components to the environment. These waste streams may result from anaerobic digestion of sewage or animal wastes, from industrial processes such as rendering operations, from coke and chemical manufacture, and from food and agricultural processes. A component which it is especially useful to separate from a nitrogen-containing waste stream (such as those types of waste streams mentioned above) is ammonia.

Anaerobic fermentation or digestion is a widely-practiced method of treating these nitrogen-containing wastes. The anaerobic fermentation process involves converting degradable carbon compounds into methane and carbon dioxide, while simultaneously converting fixed, carbonaceous nitrogen into ammonia.

Anaerobically digested sewage sludge and animal wastes may be separated into a solids-rich stream and a solids-depleted stream, where the solids-depleted stream contains the bulk of the water as well as a variety of chemicals dissolved and suspended in the water. When the digested waste is de-watered, a sludge or biosolids cake is formed (the solids-rich stream) along with a liquid stream often called a filtrate or centrate (the solids-depleted stream). The suspended chemicals in the solids-depleted stream typically include ammonia nitrogen (NH₃—N) having a typical concentration ranging from 400 parts per million (ppm) to 16,000 ppm, hardness in the form of calcium carbonate with a typical concentration ranging from 50 ppm to 350 ppm, phosphate having a typical range of concentration from 2 ppm to 150 ppm, and total suspended solids having a typical concentration range of 500 ppm to 2,000 ppm. The filtrate or centrate (solids-depleted stream SD of FIG. 1) typically contains the bulk of the ammonia nitrogen generated in the anaerobic digestion process.

Ammonia is present in the waste stream typically in the ammonium cation form. This ammonium cation (NH₄⁺) may be converted to ammonia (NH₃), which may be stripped from the centrate when the centrate pH is high. In the centrate, ammonium cations are usually paired with a roughly stoichiometric amount of bicarbonate anions at anaerobically-digested stream pH levels between 6 and 9. To raise the centrate pH to a high enough level to strip ammonia from the centrate, a base must be added to convert ammonium ion to ammonia. The desired reaction from the addition of the base (represented by OH⁻ in the formula below) is as follows:

NH₄⁺+OH⁻→NH₃+H₂O

However, the presence of significant quantities of bicarbonate (HCO₃⁻) creates a highly-buffered stream that is very resistant to pH change. Addition of set quantity base to this highly-buffered stream has a much smaller effect on the stream pH because the base is consumed by reaction with the bicarbonate. If a base such as sodium hydroxide (NaOH) or calcium hydroxide (Ca(OH)₂) is added to the centrate, the bulk of the bicarbonate is converted to carbonate (CO₃⁻²) at a pH of 10.5, which is the pH required for the conversion of the bulk of the ammonium ion to ammonia. This chemical reaction of conversion of bicarbonate to carbonate in the presence of ammonium ion is as follows:

NH₄⁺+HCO₃⁻+2NaOH→NH₃⁺+2Na⁺+CO₃⁻²+H₂O

For high concentration ammonium ion systems using any form of ammonia stripping, an economically important consequence of the presence of the bicarbonate is that very high quantities of base must be added to raise the pH of the stream and convert the ammonium ion to ammonia. This effect is shown clearly in the titration data graphically illustrated in FIG. 1 by the large amount of caustic (the base sodium hydroxide) which must be added to reach the pH of 10.5 in the centrate. Highly soluble bases such as sodium hydroxide (caustic) are very costly; therefore, the requirement to add these high quantities of base increases the cost of ammonia recovery.

The large amount of base which must be added to the centrate to reach pH 10.5 is illustrated using a specific example in New York City of a typical composition of the centrate shown in FIG. 2. Shown by this example are the near stoichiometric amounts of ammonium and bicarbonate ions present in the typical centrate. The presence of this much bicarbonate in relation to the ammonium present means that nearly twice as much base would be necessary to convert the ammonium ion to ammonia than would be needed if the centrate stream were not buffered by the bicarbonate.

In addition to ammonium and bicarbonate ions, these waste streams also contain other dissolved ions such as calcium, magnesium, iron, and phosphate, also shown by the example centrate stream component concentrations in the table of FIG. 2. The concentrations of calcium, magnesium, and phosphate ions in this example are relatively low due to the inherently soft water in New York City and the digested sludge having been treated with ferric chloride prior to centrifugation. The ferric chloride lowers the pH, binds with phosphorous, and reduces the potential for struvite formation. If the pH of this centrate stream were raised above 9, struvite would form until the solubility equilibrium limit was attained. In the case of the centrate composition shown in FIG. 2, phosphate would be the limiting reactant in the formation of struvite.

If the pH of the raw centrate were raised, other precipitates including calcium carbonate, calcium phosphate, and magnesium hydroxide would form. Although the concentrations of these potential precipitates appear small, the flow rates of the centrate and the actual quantities of precipitated solids are sufficient to allow the precipitated solids to damage or clog equipment in a relatively short time. This potential clogging problem is highly undesirable to operators of wastewater (and other waste stream) plants because, as an essential regulated utility that must operate with a predictable capacity factor, reliability is highly prized. Furthermore, clogging of the equipment is undesirable because shutting down the process to clean the equipment or replace the equipment is costly due to the labor cost of cleaning the equipment, the lost output during the cleaning, and the cost of new equipment if it must be replaced.

Current ammonia recovery processes require heating at various stages of the waste steam and/or other process streams. Heating the streams during the ammonia recovery process adds significant operating costs to the ammonia recovery operation, as energy costs are already high and are rising rapidly.

There is therefore a need for an ammonia recovery process which eliminates or reduces damage to and clogging of equipment due to precipitate byproducts formed by raising the pH of a waste stream to convert the ammonium ion to ammonia, thereby reducing the cost of the ammonia recovery process as well as increasing reliability of the waste treatment. There is also a need for an ammonia recovery process which reduces the amount of base required to convert the ammonium ion present in the waste stream to ammonia. There is yet a further need for an ammonia recovery process having reduced cost and increased efficiency. Furthermore, there is a need for an ammonia recovery process which reduces operating costs of the ammonia recovery, such as by reducing heating costs of the ammonia recovery process, by reducing the damage to and/or clogging of equipment, and/or by decreasing the amount of base required to convert the ammonium ion in the waste stream to ammonia.

### SUMMARY OF THE INVENTION

It is therefore an object of embodiments of the present invention to provide an effective and efficient ammonia recovery process.

It is a further object of embodiments to provide an ammonia recovery process which is cost-effective.

It is yet a further object of embodiments to provide an ammonia recovery process which increases reliability of a waste treatment process.

It is also an object of embodiments to provide an ammonia recovery process using caustic or another base which is capable of effectively, efficiently, and cost-effectively removing ammonia from a waste stream.

It is a further object of embodiments to provide an ammonia recovery process which reduces the quantity of base required to accomplish ammonia recovery.

It is a further object of embodiments to reduce or eliminate damage to and clogging of waste treatment equipment due to precipitate byproducts formed when raising the pH of a waste stream to convert the ammonium ion to ammonia.

It is yet a further object of embodiments to reduce operating costs of the ammonia recovery system.

It is also an object of embodiments to reduce or eliminate heating costs associated with the ammonia recovery process.

Yet another object of embodiments is to provide apparatus for accomplishing the above ammonia recovery process.

Toward fulfillment of these and other objects and advantages, embodiments include a method for removing ammonia from a stream, the stream comprising therein soluble ammonia, ammonium ions, or a combination thereof and carbonate anions, bicarbonate anions, or a combination thereof, the method comprising reducing suspended solids from the stream by flotation, settling, or filtration; removing divalent and trivalent cations from the stream via ion exchange; converting any carbonate anions, bicarbonate anions, or the combination thereof in the stream to carbon dioxide by adding an effective amount of one or more acids; removing the carbon dioxide from the stream using one or more mass transfer devices; converting the ammonium ions to ammonia by adding an effective amount of one or more bases; and removing ammonia from the stream by converting the ammonia into a gaseous form and absorbing the gaseous ammonia into a separate solution. Embodiments also include a method for removing ammonia from a stream, the stream comprising therein soluble ammonia, ammonium ions, or a combination thereof and carbonate, comprising reducing suspended solids from the stream by flotation, settling, or filtration; removing divalent and trivalent cations from the stream via ion exchange; absorbing any remaining ammonium ions in the stream onto an ion exchange resin; regenerating the ion exchange resin to form a high-ammonia spent solution; converting any ammonium cations in the high-ammonia spent solution to ammonia by addition of one or more bases; and recovering the ammonia from the spent solution by converting the ammonia into a gaseous form and absorbing the gaseous ammonia into a separate solution.

Further embodiments of the present invention include a method for removing ammonia from a waste stream, the waste stream comprising therein soluble ammonia, ammonium ions, or a combination thereof and carbonate anions, bicarbonate anions, or a combination thereof, the method comprising reducing suspended solids from the waste stream by flotation, settling, or filtration; removing divalent and trivalent cations from the waste stream via ion exchange using one or more ion exchange softening columns; diverting flow of the waste stream from a carbon dioxide stripping column and an ammonia stripping column disposed downstream from the one or more ion exchange softening columns; using the waste stream to convert one or more freshly regenerated ion exchange softening columns to ammonium form; and returning the one or more ion exchange softening columns to ion exchange service. Yet further embodiments include a method for removing ammonia from a stream, the stream comprising therein soluble ammonia, ammonium ions, or a combination thereof and carbonate anions, bicarbonate anions, or a combination thereof, the method comprising reducing suspended solids from the stream by flotation, settling, or filtration; removing divalent and trivalent cations from the stream via ion exchange; removing the bicarbonate anions from the stream via ion exchange; if any carbon dioxide is present in the stream, removing the carbon dioxide from the stream using one or more mass transfer devices; converting the ammonium ions to ammonia by adding an effective amount of one or more bases; and removing ammonia from the stream by converting the ammonia into a gaseous form and absorbing the gaseous ammonia into a separate solution.

### BRIEF DESCRIPTION OF THE DRAWINGS

So that the manner in which the above-recited features of embodiments of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a graph of titration data illustrating buffering effect of 3500 parts per million (ppm) bicarbonate in a centrate, where 3,500 ppm bicarbonate is titrated with 0.05M sodium hydroxide.

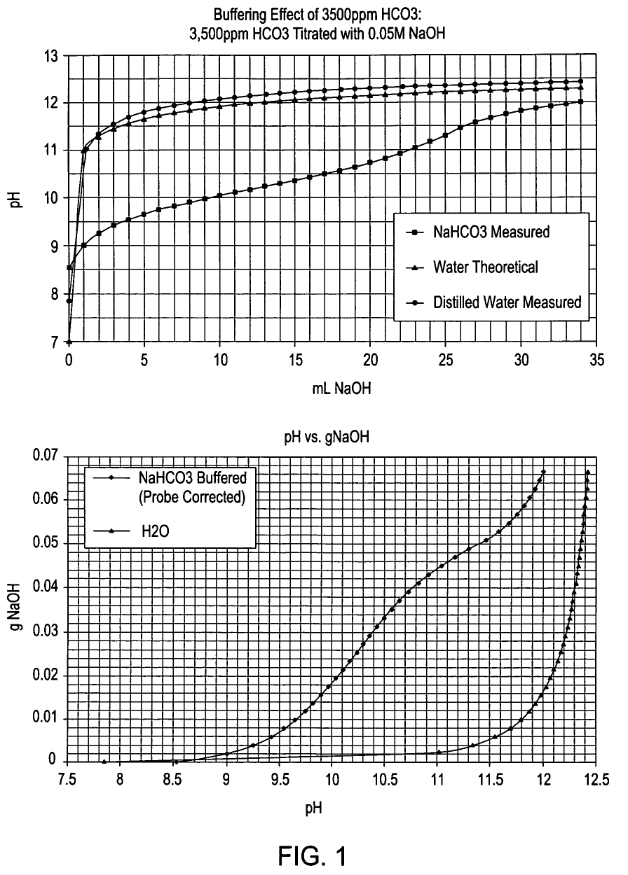

FIG. 2 is a table showing analysis of a typical centrate composition, the composition data from Bowery Bay Water Pollution Control Plant in New York City.

FIG. 3 is a flow chart of a first embodiment of an ammonia recovery process.

FIG. 4 is a graph showing an ammonium load breakthrough curve.

FIG. 5 is a flow chart of a second embodiment of an ammonia recovery process.

### DETAILED DESCRIPTION

Embodiments of the present invention include a method and device for effectively, efficiently, and cost-effectively removing ammonia from a nitrogen-containing waste stream such as a wastewater or landfill leachate. Useful and valuable quantities of ammonia are recovered from a waste stream by use of methods and equipment of embodiments. The waste stream may result from any process known to those skilled in the art which generates waste containing ammonia or the precursors to ammonia (nitrogen containing wastes), including but not limited to streams from anaerobic digestion of sewage or animal wastes, streams from industrial processes such as rendering operations and coke and chemical manufacturing processes, or related streams from food and agricultural processes.

Embodiments encompass an ammonia recovery process including low-cost bicarbonate buffer removal. Ammonia recovery process embodiments of the present invention address the conflicting requirements and constraints associated with recovering ammonia from a waste stream in a highly reliable, cost-effective manner which includes reducing the amount of base needed to recover ammonia from the waste stream. The processes and methods of operation of embodiments achieve a high degree of process equipment reliability by eliminating or reducing the potential for undesired solids precipitation (example undesired solids are calcium carbonate, calcium phosphate, magnesium ammonium phosphate hydrates (struvite), and magnesium hydroxide) in the equipment and/or associated valves, pipes, etc. Cost effectiveness is increased by using counter-intuitive, low-cost methods to eliminate the buffering effect of the bicarbonate anion. Embodiments eliminate the bicarbonate ion prior to addition of base, thereby reducing the quantity of base that is necessary to recover the ammonia from the waste stream. Some embodiments also eliminate the formation and collection of precipitates or solids by removing divalent and trivalent cations, the precipitate-forming materials, via ion exchange softening. Wastewater is particularly susceptible to the formation of precipitates or solids such as calcium carbonate, calcium phosphate, and struvite due to the presence of calcium, ammonium, magnesium, and phosphate ions (the components which form struvite and the calcium precipitates) in the wastewater; therefore, the elimination of divalent and trivalent cations is particularly advantageous in the context of wastewater treatment. Beneficially, no sludge is produced after ion exchange softening when recovering the ammonia with the use of one or more highly soluble bases such as sodium hydroxide instead of lime to convert ammonium to ammonia and to the use of one or more acids such as sulfuric acid to blow off the carbon dioxide prior to the ammonia removal.

In the ammonia recovery process of embodiments, carbonate or bicarbonate present in the waste stream is the corresponding anion for both the ammonium and divalent cations such as calcium and magnesium. The divalent cations are removed up front in the ammonia recovery process so that solids (precipitates) are not formed (or at least negligible amounts of solids are formed) during the ammonia recovery process. Removing the bicarbonate up front reduces the amount of base necessary to recover the ammonia, thereby reducing the expense of the ammonia recovery process and increasing its efficiency. All or a portion of the bicarbonate and carbonate anions may be removed from the stream using anion exchange with a strong base anion resin in the chloride form. The salt brine used to regenerate the strong base anion resin may, in most cases, be used simultaneously or in series the regenerate the strong acid cation resin used to remove the divalent and trivalent cations. Because the bicarbonate is typically present in a molar-equivalent amount significantly greater than the molar-equivalent amount of divalent and trivalent cations, there will typically be a mismatch between the amount of salt brine needed for anion resin regeneration and cation resin regeneration. In general with anaerobically digested wastes, the anion resin regeneration will require more brine than the cation resin. The brine necessary for the anion resin regeneration can be fully provided and thereby provide an excess of brine for the cation regeneration step. Alternatively, a quantity of brine sufficient to regenerate the molar equivalents of hardness on the cation resin and a molar equivalent amount of amount of bicarbonate on a corresponding quantity of anion resin may be provided. In the case where the molar equivalent capacities of the cation and anion resins were roughly the same, the anion resin would exhaust before the cation resin, and the bicarbonate anion would pass through the column. This remaining bicarbonate slip may be treated with acid to convert the bicarbonate to carbon dioxide, and then the carbon dioxide would be removed as a gas. At some point after the waste stream passes through an anaerobic digester (and possibly an anion resin), one or more acids (e.g., sulfuric acid) may be utilized to convert bicarbonate to carbon dioxide (CO₂), which is then removed from the waste stream as a gas, so that when the pH of the product stream is raised to form a more basic solution (such as by adding caustic), the amount of material utilized to raise the pH value of the product stream is decreased. By decreasing the amount of material needed to raise the pH value of the product stream, the expense of the ammonia recovery operation may be reduced due to the high expense of the material used to raise the pH (e.g., sodium hydroxide, caustic, and other soluble bases are relatively expensive).

Embodiments of the ammonia recovery process may include filtration, ion exchange, pH modification, gas stripping (contacting the liquid stream with inert gas to remove volatile components), and absorption (to remove contaminants from the gas stream). Chemical inputs to the ammonia recovery process system may include polymer flocculent for addition to a dissolved-air flotation tank, as well as one or more bases such as sodium hydroxide (NaOH) or calcium hydroxide (Ca(OH)₂), one or more acids such as sulfuric acid (H₂SO₄), and sodium chloride (NaCl) (or their chemical equivalents) for ammonia recovery.

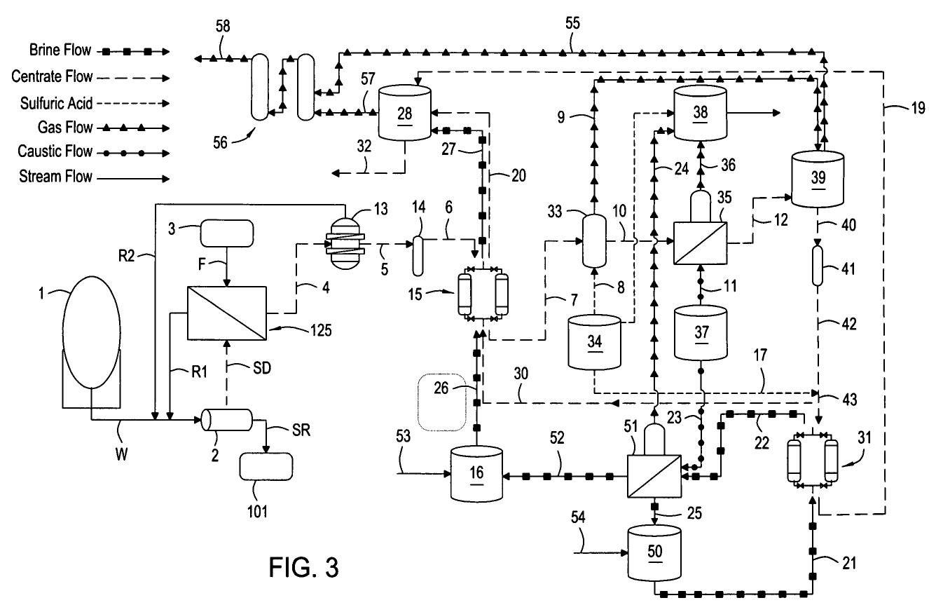

In embodiments, useful and valuable quantities of ammonia are recovered from a waste stream using various processes and equipment. FIG. 3 shows a first embodiment of the ammonia recovery process of the present invention. Generally, the first embodiment includes the method steps of filtering out suspended solids from the waste stream, softening the centrate to produce high ammonium content therein, removing the bicarbonate buffer, stripping ammonia (ammonia polishing) to convert the ammonium ion to ammonia and raise the pH of the centrate, and accomplishing absorption of the excess carbon dioxide.

As shown in FIG. 3, the waste stream, which may include for example sewage sludge or animal wastes (but may also include waste resulting from industrial processes such as rendering operations or food or agricultural processes, or from coke or chemical manufacture), is anaerobically digested by an anaerobic digester 1 to produce a digested sludge or waste stream W. This digested waste stream W typically has a substantially neutral pH value (a pH of approximately 7).

In a preferred embodiment, the typical operational temperature of the anaerobic digester 1 is sufficient to provide the heat needed in the ammonia recovery process to recover the ammonia without additional heat exchange. Because the energy requirements of the system are greatly reduced by the elimination of the prior art requirement that other steps of the ammonia recovery process be heated, embodiments of the ammonia recovery process and system allow for low energy costs greatly reduced from the energy requirements of the prior art. Of course, it is also within the scope of alternate embodiments of the present invention to heat any of the stages, equipment, or streams of the ammonia recovery process if desired or necessary. In embodiments of the present invention, instead of added heat to the ammonia recovery system removing the ammonia, pressure is utilized to remove the ammonia from the waste stream.

The digested sludge W is then separated into a solids-rich stream SR and a solids-depleted stream SD (also referred to as “centrate” or “filtrate”). The digested sludge W may be separated into these streams SD and SR by one or more separating devices 2, which may include one or more of any separating or filtering devices known to those skilled in the art, including but not limited to one or more centrifuges, filter presses, settling basins, and/or other filtering devices.

The solids-depleted stream SD contains the bulk of the water as well as a variety of chemicals dissolved and suspended in the water, the dissolved and suspended chemicals typically including ammonium bicarbonate (NH₄HCO₃), calcium bicarbonate (Ca(HCO₃)₂) as the hardness, phosphate, and suspended solids. Some typical concentration ranges of these chemicals dissolved and suspended in the water are shown in Table 1 below:

TABLE 1

| | Typical Concentration Range (End | |
|---|---|---|
| Constituent | values of ranges are approximate) | |
| ammonia nitrogen | 400–16,000 | parts per million (ppm) |
| calcium carbonate | 50–350 | ppm |
| phosphate | 2–150 | ppm |
| total suspended solids | 500–2,000 | ppm |

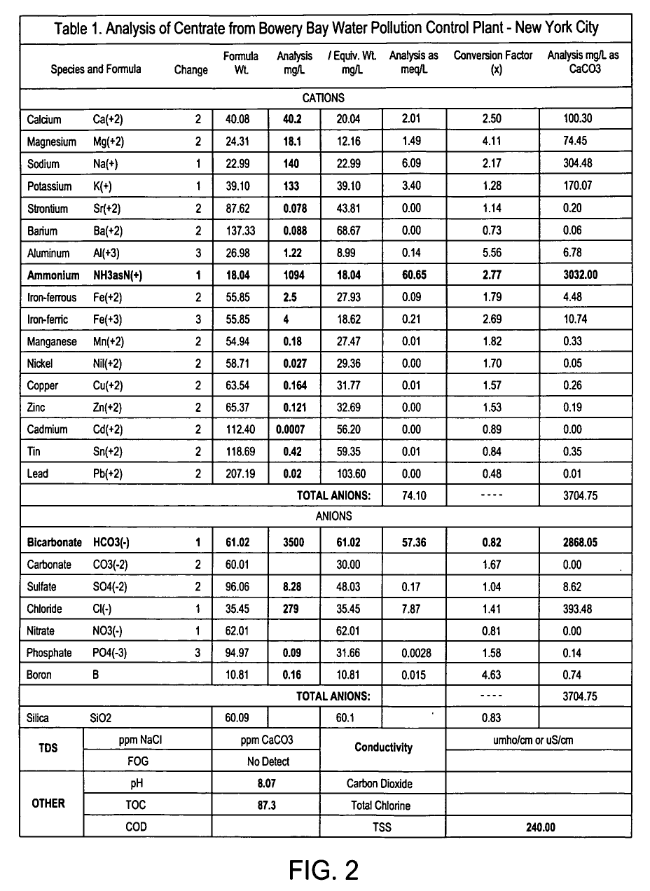

Of course, the solids-depleted stream SD may contain other chemicals in addition to those listed above, and/or the constituents may be present in the solids-depleted stream SD in different concentrations. The solids-depleted stream SD may be a centrate stream, while the solids rich stream SR may be a bio-solids cake. FIG. 2 shows a specific example of the concentrations of different components present in a centrate or solids-depleted stream in New York City.

After separating the solids-depleted stream SD from the solids-rich stream SR, the solids-rich stream SR containing bio-solids, the solids-rich stream SR may be collected in a vessel 101, further treated, or otherwise removed from the remainder of the ammonia recovery process.

The solids-depleted stream SD, which contains raw centrate or filtrate from centrifuging or filtering equipment (or other separating equipment), may still contain suspended solids which must be removed prior to ammonia recovery processing. A highly robust approach to removing these suspended solids couples dissolved air flotation with one or more multi-media and/or cartridge filters to achieve a low suspended solids stream. Depending upon the quantity of suspended solids present in the stream and their nature, one or more microfilters may optionally be utilized.

Specifically, referring to FIG. 3, the solids-depleted stream SD may enter another separating/filtering device, specifically a dissolved air flotation unit (“DAF unit”) 125. One or more flocculating agents or flocculents F are flowed into a dissolved air flotation unit (“DAF unit”) 125, for example from tank 3. The DAF unit provides means for removal of solids from the waste stream by injection of extremely fine air bubbles. Optionally, to effect further separation of the suspended solids from the waste stream, a high-solids return stream R1 of the solids-depleted stream SD may be combined with the waste stream W feeding into the separating device(s) 2 and then recycled back to the inlet of the one or more separating devices 2, so that the return stream R1 again passes through the separating device(s) 2 and DAF unit 125.

The filtered stream 4 exiting from the DAF unit 125 enters one or more filtering devices, such as one or more multimedia filters 13, and the filtered centrate stream 5 exiting from the one or more multimedia filters 13 may be further filtered using one or more cartridge filters 14. Although not shown, the filtered centrate stream 6 may optionally be further filtered by one or more microfilters to effect further filtration of the suspended solids from the stream 6. Optionally, a high solids return stream R2 from the multi-media filter(s) 13 may be returned to the inlet of the separating device(s) 2 to allow for further filtration of the return stream R2 via another pass through the filtering devices 2, 125, 13, and 14.

In other embodiments, the multi-media filter(s) 13, cartridge filter(s) 14, and/or microfilter(s) may be used to filter the solids-depleted stream SD in different orders than that shown in FIG. 3, according to the specific application. Ultimately, the filtered centrate stream 6 proceeds to the softening step described below.

The softening step involves softening the centrate to prevent formation of precipitates in the process equipment. To soften the centrate, the centrate stream 6 is flowed through one of the two or more softening columns 15, the softening columns preferably being two or more cation exchange softeners and more preferably being two or more cation and ion exchange softeners. (In an alternate embodiment, only one softening column is placed within the ammonia recovery process.) The two or more softening columns 15 may be operated in a mode where at least one column is online while at least one column is offline and available for regeneration. This operational mode decreases the cost of the ammonia recovery process.

The softening column(s) 15 operate via ion exchange to remove precipitate-forming materials, such as calcium, magnesium, and iron ions, so that precipitates are not formed and do not cling to equipment walls to clog or damage other pieces of equipment in the ammonia recovery process and do not cling to walls of piping or other equipment to clog or damage piping or other equipment conveying the treated waste stream back to the plant. Especially in the context of water plants, the treated water often travels for several miles through possibly underground piping and equipment from the water treatment plant where the ammonia recovery operation occurs to the water plant. When piping and equipment is located underground, it is difficult and costly to diagnose the extent that precipitants have clogged or damaged the piping or equipment, and it is even more costly to repair or replace this piping and equipment by digging up the piping or equipment. Therefore, effectively removing the precipitates and precipitate-forming materials during the ammonia recovery process prior to returning the treated waste stream back to the plant is extremely valuable. Furthermore, removing precipitates and precipitate-forming materials prior to the centrate proceeding to the ammonia stripping step of the process also prevents clogging and damage to ammonia stripping equipment and the other equipment and piping subsequent to the softening column(s) 15. Removing the precipitates and precipitate-forming materials increases efficiency and reliability of the ammonia recovery system and decreases cost of the ammonia recovery process.

In an embodiment, the filtered centrate 6 is passed over a standard strong acid cation resin bed where calcium, magnesium, and iron ions are removed. Potassium and ammonium have fairly similar affinities for the strong acid cation resin. Potassium will typically displace ammonium, but in the case of the influent centrate, the concentration of ammonium ions is roughly 18 times the concentration of the potassium ions. Depending upon the resin, a sharp separation between the potassium and ammonium ions may or may not be achieved. For the purposes of this analysis, consider the case where a reasonably sharp split between the potassium and ammonium ions is achieved. Assuming this sharp split imposes additional processing costs because it will be necessary to regenerate the softening column more frequently. Also, a purge or other treatment process must be added to the recirculated brine used to regenerate the polishing columns (described below).

Each equivalent of potassium and hardness in the influent filtered centrate 6 is exchanged for an equivalent of ammonium ion in the online softening column 15. The ammonium concentration increases as the potassium and hardness is captured by the online softening column 15 by displacing ammonium ions, and the potassium and hardness is thereby eliminated (or at least reduced) from the centrate stream 6. When the online softening column 15 is saturated with potassium and hardness, the potassium in the feed will begin to break through, but the hardness will not. The hardness will displace the potassium on the online softening column 15. The softening column(s) 15 remove(s) precipitate-forming materials from the centrate of the waste stream, preventing precipitates from forming and clogging or damaging pipes or other equipment.

When the online softening column 15 is fully saturated with potassium and hardness (calcium, magnesium, and iron) and the ammonium ions on the online softening column 15 have been replaced with potassium and hardness, the online softening column 15 may be regenerated with sodium chloride (NaCl) brine solution 26 (and/or with sodium hydroxide, sodium chloride, brine, or a combination thereof). The sodium chloride brine solution 26 may be dispensed from a brine regeneration solution tank 16, where the water and sodium chloride solution is located. The high concentration of sodium chloride in the brine stream 26 replaces the hardness on the online softening column 15 with sodium ions. The spent brine stream 27 is purged from the online softening column 15 and may be discharged to a pH balance tank 28. At this point, the brine regenerated column in the sodium form is converted to ammonium form by using the freshly-generated sodium form softener column as an ammonium ion polishing column until the sodium is displaced with the ammonium ion. The pH-adjusted stream 30 is split off before the ammonia polishing operation (described below) and is used to convert the sodium form online softening column 16 to the ammonium form. The treated low ammonia effluent stream 20 is pH adjusted, for example in the pH balance tank 28, and returned to the treated water plant as stream 32.

In the present example using the centrate composition shown in FIG. 2 and a net flow rate of approximately 1,316 liters per minute, a 3-meter diameter and 1.9-meter high resin bed with a capacity of 1.2 equivalents per liter, the bed would require approximately 28 hours to load with potassium and hardness before its need for regeneration would arise. In comparison, the partially-treated ammonium laden stream 30 from the entry to the ammonia polishing column(s) 31 (described below) is capable of displacing the sodium in approximately 16 hours of operation. In this example, for about 56% of the time, the softening column that is offline from softening duty may be operational for ammonium polishing duty. With improvements to the ammonia polishing column(s) 31 operation, the concentration of ammonia in the partially-treated stream 30 may be reduced and the time the offline softening column may be used for polishing is extendable. The benefits of this approach are explained below after this description of the entire ammonia recovery process.

The next step in the ammonia recovery process is the bicarbonate buffer removal. In the case where all of the bicarbonate has not been removed by ion exchange on a strong base anion exchange resin in the chloride form, or in the case where additional bicarbonate buffer removal is required, it is accomplished by addition of an acid such as sulfuric acid, which may be accomplished by flowing a sulfuric acid stream 8 from a sulfuric acid tank 34, and a carbon dioxide removal unit 33. Bicarbonate buffer removal occurs as part of the ion exchange softening process where the bicarbonate ion is exchanged for chloride using a strong base anion resin and/or when the softened, high-ammonium centrate stream 7 which exits from the online softening column 15 flows into the carbon dioxide removal unit 33 to react with an acid. Sulfuric acid (or other acid) also flows into the carbon dioxide removal unit 33 (for example from tank 34) via sulfuric acid stream 8. The softened, high-ammonium centrate stream 7 is acidified with the sulfuric acid 8 to a pH of approximately 5.3, and the sulfuric acid reacts with the bicarbonate in the centrate stream 7 to form carbon dioxide and water. (The pH of the centrate stream 7 is preferably generally neutral, at approximately 6 to approximately 8, before entering the carbon dioxide removal unit 33.) The chemical reaction of the bicarbonate in forming the carbon dioxide upon addition of the acid is as follows (where HCO₃⁻ represents the bicarbonate anion in the centrate stream and H⁺ represents the added acid):

HCO₃⁻+H⁺→CO₂+H₂O

Upon formation of the carbon dioxide in the carbon dioxide removal unit 33, the carbon dioxide is removed into carbon dioxide stream 9 (which may also contain air) using the carbon dioxide removal unit 33, which may include an air blown packed or similar mass transfer column or a vacuum degassing unit. Although the vacuum degassing unit is typically more costly to build and run than the mass transfer column, the vacuum degassing unit generates a high-concentration carbon dioxide stream 9 (or carbon dioxide/air stream). The carbon dioxide stream 9 (or carbon dioxide/air stream) is preferably not immediately discarded, but is instead re-used and a portion thereof returned to the partially-treated centrate in a subsequent step of the ammonia recovery operation to reduce pH of the partially-treated centrate (although it is within the scope of embodiments of the present invention to discard this carbon dioxide or carbon dioxide/air stream).

Because the next process of ammonia removal (ammonia stripping or ammonia polishing), which is the ultimate aim of the ammonia recovery process, requires the pH to be raised to approximately 10.5, it would appear to be counterproductive and would be counterintuitive to add acid prior to adding the required base. However, using one or more acids for bicarbonate buffer removal was discovered by the present inventor to be highly economically favored due to the low cost of sulfuric acid (and/or other comparable acids) in comparison to the cost of sodium hydroxide (and/or other comparable bases), and due to the relatively small amounts of acid and base needed to shift the pH once the bicarbonate buffering capacity was eliminated in comparison to the large amount of base needed to raise the pH to 10.5 when the bicarbonate was present. For example, with the centrate stream of FIG. 2, about 11,000 times more acid is required to convert the bicarbonate to carbon dioxide than it takes to adjust the pH once the bicarbonate buffer is eliminated. Rather than using excess sodium hydroxide (and/or other comparable base) to convert the bicarbonate to carbonate, as would be required in the buffered case shown in FIG. 2, far less sodium hydroxide can be utilized, as shown in the unbuffered case.

The benefit of using sulfuric acid to remove the bicarbonate buffer from the centrate stream is that sulfuric acid is and generally will be less costly to use for this application than sodium hydroxide. Sulfur and sulfuric acid are byproducts of energy production and have low and stable costs. In contrast, sodium hydroxide and other comparable bases are made using electricity to split salt to form chlorine and sodium hydroxide; therefore, sodium hydroxide is expensive and becoming even more expensive. Using low-cost sulfuric acid (or other comparable acid) in this counter-intuitive manner enables significant cost savings in ammonia recovery from bicarbonate buffered streams. When this method is combined with varying degrees of bicarbonate removal by anion exchange, less bicarbonate ion remains in the solution to be treated and correspondingly less acid is needed to eliminate the remaining bicarbonate.

After the bicarbonate buffer is removed, the unbuffered stream 10 proceeds to the next step of ammonia stripping (this term denotes removing ammonia from the stream and is also called ammonia polishing). To this end, the stream 10 flows to ammonia stripper 35, which may be a vacuum stripping unit, vacuum stripper, vacuum distillation unit, and/or air stripper unit, where the pH of the stream 10 is raised to approximately 10.5 by one or more bases flowing into the ammonia stripper 35 via base stream 11, and the ammonia is removed as a gas via ammonia stream 36. The base stream 11 is added to react with the ammonium ion and convert it to ammonia as well as to raise the pH to approximately 10.5. In the preferred embodiment where a vacuum stripper is used as the ammonia stripper 35, the base (which may be in the form of caustic) addition is performed in or before the circulation pump. The chemical reaction upon addition of the one or more bases (represented by OH⁻) is as follows (where NH₄⁺ is the ammonium cation):

NH₄⁺+OH⁻→NH₃+H₂O

Specifically, when using sodium hydroxide as the base, the chemical reaction is as follows:

NH₄⁺+NaOH→NH₃+Na⁺+H₂O

The base stream 11 may be supplied by base tank 37, and the base may be sodium hydroxide. The ammonia gas stream 36 may flow into a product tank 38 (which may hold therein a product of ammonium sulfate formed from ammonia gas in combination with sulfuric acid and other process streams).

A vacuum may be maintained within the ammonia stripper 35 using a venturi and circulation pump. The pump circulates a concentrated solution of ammonium sulfate and sulfuric acid (or other comparable acid and ammonium acid compound) at a rate that captures all of the ammonia and water vapor pulled into the venturi via ammonia stream 36. This same process is achievable using an atmospheric pressure stripper and absorber where a gas, such as air, is circulated between a mass transfer column, where ammonia is stripped from the high-pH liquid into the gas, and an absorber, where ammonia is absorbed into a low-pH solution of ammonium sulfate and sulfuric acid. The rate of ammonia gas mass transfer in both stripping cases decreases as the concentration of ammonia in the centrate decreases. By their natures, these stripping devices are roughing devices well-suited for high concentrations of ammonia, but they are limited in suitability for low concentrations of ammonia in the centrate because mass transfer slows down as the ammonia concentration decreases. Practical testing and experience with these devices, although in no way limiting to embodiments of the present invention, indicate that an optimal performance range of approximately 100 ppm to approximately 300 ppm ammonia nitrogen in the effluent (the high-pH partially-treated centrate 12 exiting the stripper 35), where the set point ammonia concentration is approximately 225 ppm ammonia nitrogen. Since the allowable throughput for the mass-transfer equipment is controlled by setting the effluent value on the low end, modest changes to the concentration of the feed, such as that described in the ammonia softening portion of this disclosure, will have little or no noticeable impact on the performance of the stripping mass transfer device 35.

An advantage of using a vacuum stripper rather than an air stripper is that dealing with air as an intermediate in the process is eliminated, so that the ammonia recovery process is accomplished in less time at less cost for several reasons. First, mass transfer using an air stripper involves two time-consuming mass transfer steps, where in the first step ammonia must mix with air, and then in the second step the contents of the air stripper must change to the liquid phase while the ammonia is removed as a gas. Second, an air stripper requires heating for the mass transfer to occur, thereby increasing the energy costs for operating the system. In contrast, in embodiments of the present invention, where a vacuum stripping unit/vacuum stripper is utilized as the liquid/gas mass transfer device 35, the pressure in the device is preferably maintained at a vacuum (with a preferable pressure of from approximately 1 absolute pressure per square inch (psia) to approximately 2.5 psia, most preferably approximately 1.9 psia, although this pressure range and preferable pressure are in no way limiting of the pressures at which the stripper mass transfer unit 35 may be maintained in embodiments or of the pressures at which a vacuum occurs in embodiments). When the pressure is maintained at a vacuum in the vacuum stripping unit 35 (the pressure being maintained at the vacuum and the vacuum created by the venturi circulation pump, for example), and the one or more bases 11 react with the centrate stream 10 to rapidly and simultaneously convert the ammonium ion into dissolved ammonia, the liquid stream is provided a high surface area where the volatile ammonia passes into the gas phase. A significant advantage of the vacuum approach is that a large mass fraction gas phase is ammonia as opposed to water (the ammonia vapor 36), and the gaseous ammonia is separated from the partially treated centrate stream 12 in the liquid phase. The ammonia vapor in stream 36 instantly reacts with the acid liquid stream in tank 38 to form concentrated ammonium salt solutions such as ammonium sulfate. Thus, instantaneous ammonia conversion occurs when using the vacuum stripper and liquid venturi. Vacuum stripping is faster than the air stripping (1 step versus 2 steps), does not require dealing with an air intermediate, and does not require any heating for the mass transfer to occur because the mass transfer in the vacuum stripping occurs due to pressure rather than temperature. For all of these reasons, vacuum stripping is less costly and simpler than air stripping.

The absorption step, where excess carbon dioxide is absorbed, involves contacting the high-pH partially-treated centrate stream 12 exiting the ammonia stripper 35 and the carbon-dioxide-containing exhaust stream 9 from the degassing unit 33 in a carbon dioxide absorption tank 39. The absorption tank may include a liquid-vapor mass transfer device, for example a packed column. Because a significant amount of ammonia was previously removed from the exhaust stream 9, a significant excess of carbon dioxide is available to react with the high-pH partially-treated centrate stream 12 to reduce its pH. Recovering a portion of the carbon dioxide byproduct and utilizing the resulting available carbon dioxide containing stream 9 saves sulfuric acid (or other acid being used in the ammonia recovery operation). The partially-treated centrate stream 40 exits from the absorption tank with a lower pH, in one embodiment with a pH of from approximately 8 to a pH of approximately 10. In alternate embodiments, the carbon dioxide containing stream 9 is not added to the absorption tank 39, and the sulfuric acid (or other acid) added in subsequent steps (e.g., via stream 17) is used to lower the pH to the desired generally neutral value.

After the partially-treated centrate stream 40 exits from the absorption tank 39, the partially-treated centrate stream 40 may optionally be filtered by one or more optional filtering devices, for example by one or more cartridge filters 41. The filtered centrate stream 42 exits from the one or more filtering devices.

Optionally, sulfuric acid (or other comparable acid) may be added via acid stream 17 (for example from the sulfuric acid tank 34, although a different tank may also be utilized) to the filtered centrate stream 42 (or to the stream 40 if no filtering devices 41 are present), as needed, to further reduce the pH of the stream 40 or 42 to result in a pH ranging from approximately 6 to approximately 7 in stream 43, thereby ensuring that all of the ammonia remaining in the stream 40 or 42 is converted to the ammonium form. With or without the addition of sulfuric acid, the desired result is stream 43 having a generally neutral pH.

Stream 43 may be split into two streams 30 and 18, each having a pH of approximately 7 and a concentration of ammonium nitrogen of approximately 225 ppm. Streams 30 and 18 are sent to different places for different amounts of time. Stream 30 flows into the softening operation to convert the sodium column to an ammonium column (softener regeneration), while stream 18 flows into the polishing operation (described below).

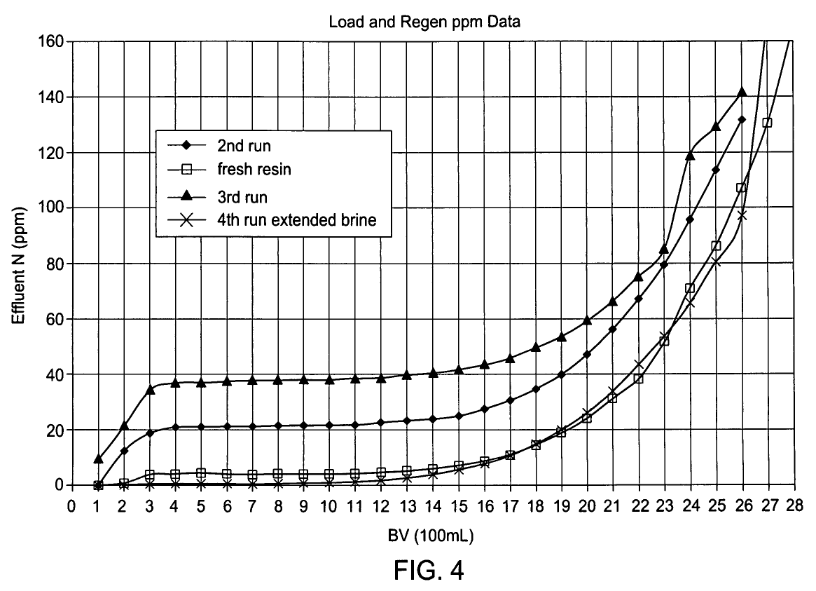

Stream 30 is sent to the online brine regenerated softening column 15 to convert it to the ammonium form. Converting the softening column 15 to the ammonium form improves the overall process and utilizes ammonia adsorption capacity which would otherwise be wasted. If the softening columns 15 were placed back into operation without this conversion to the ammonium form, all of the ammonium ions would displace the sodium ions on the softening columns 15, and for a time no ammonium would exit the softening columns 15. The graph of FIG. 4, which illustrates this undesirable result when the softening columns 15 are not converted to ammonium form, shows the absorption breakthrough curves for the ammonium ion from the example centrate stream of the table of FIG. 2 after multiple regeneration steps using brine as the regenerant. Note that low levels of ammonium ions are achievable. The data in FIG. 4 was generated using centrate having approximately 1,000 ppm ammonium nitrogen, and improved performance is expected in industrial-sized columns being fed approximately 225 ppm ammonium concentration.

If the softening columns 15 were put back into softening service without conversion to the ammonium form, the softening columns 15 would simply absorb all of the ammonium ions in stream 6 until the sodium was no longer present, and the softening columns 15 would then operate as an ammonium softening column for the remainder of its softening capacity. In the current example, if stream 6 were sent to a freshly regenerated online softening column 15 in the sodium form, approximately 3.7 hours would pass before any ammonium ions exited the softening column 15. During this time, the ammonium ions in stream 6 would displace the sodium on the softening column 15, while the downstream processing equipment would not be processing anything. From a process control viewpoint, this 3.7-hour gap is a step function that would repeatedly introduce significant process control challenges every 28 hours, disadvantageously requiring downstream equipment to idle or shut down and be restarted. Therefore, by utilizing the sodium-form softening column 15 as a polisher for stream 30, the step function is avoided in normal operation of the equipment, and the equipment and chemical use efficiencies are realized.

The embodiment of FIG. 3 provides an ammonia recovery process possessing an intrinsic alternate capacity which allows the carbon dioxide and ammonia removal equipment to be bypassed for a set window of time without the loss of plant performance, enabling maintenance, repair, and/or replacement of the carbon dioxide and/or ammonia removal equipment without complete shutdown of the overall operation for a period of time. In the event that scheduled or unscheduled repair, replacement, or maintenance on the carbon dioxide removal equipment or the ammonia removal equipment is necessary or desired, the sodium form softening columns 15 could be used to provide approximately 3.7 hours of ammonia capture, allowing the flow to the carbon dioxide removal equipment and ammonia removal equipment to be bypassed. To bypass this equipment, the direction of fluid flow in the line containing stream 30 is reversed, and the centrate stream flows from the softening column 15 directly to the polishing columns 31 instead of to the degassing unit 33 as stream 7. Presuming the polishing columns 31 are the same size as the softening columns 15 (which is not required for embodiments of the present invention), then adding the capacity of the polishing columns 31 to the capacity of the softening columns 15 would add an approximately 3.7 to approximately 7.4 hours of additional treatment capacity to the ammonia recovery system. Ultimately, up to approximately 11.1 hours of capacity would be provided by this mode of operation using polishing columns 31 in addition to the softening columns 15 where the carbon dioxide and ammonia removal equipment could be bypassed. This increased built-in capacity is particularly useful for processing sites having limited space, where the normal design practice of ensuring reliability by using redundant equipment may be difficult or precluded due to this lack of available space. Furthermore, the additional built-in capacity is useful when the ability to schedule down-time is precluded because the centrate feed needs processing 24 hours/day, 7 days/week, and 365 days/year, so that minimal or no routine down-time is desired, even for routine maintenance. These constraints are real for many large, urban wastewater treatment plants.

Stream 18 flows through ammonia polishing columns 31 (preferably, although not necessarily, at least two columns), where the ammonium ions are exchanged with the sodium ions on the ammonia polishing columns 31. The ammonium polishing columns 31 may be designed to meet design criteria including minimum process unit capital cost, some equipment size restraints, maximum spent brine ammonium concentration, and/or adequate back-up processing capacity in the event of a bypass situation as described above.

An optional second ammonia stripper 51, which may be a vacuum stripping unit, vacuum stripper, distillation unit, air stripper unit, another type of vacuum unit, or any other gas stripping or gas removal unit known to those skilled in the art, may be disposed downstream of the ammonia polishing columns 31 to remove any remaining ammonia gas 24 from stream 22 exiting from the polishing columns 31. Stream 22, which contains mostly brine, flows into the vacuum unit 51, and any ammonia gas 24 is stripped from this stream 22 and sent to product recovery, for example to the product tank 38 (the product may be ammonium sulfate).

The ammonia polishing columns 31 may be regenerated by a brine solution (and/or with sodium hydroxide, sodium chloride, brine, or a combination thereof), delivered for example via brine regeneration solution stream 21 from a brine regeneration solution tank 50 (containing water and sodium chloride therein). The ammonium polishing column regeneration brine solution 21 may be continuously reused, as sodium from the base tank 37, base stream 23 (which may be a base such as caustic or sodium hydroxide), continuously replaces the sodium lost in the ammonia polishing columns 31 during the ion exchange with the ammonium ion. (In an alternate embodiment, sulfuric or hydrochloric acid may optionally be utilized to regenerate the columns 15 and/or 31.)

Brine flowing through the ammonia stripper 51 via stream 22 may be split into two brine streams, namely a first brine stream 52 recycled back into the brine regeneration solution recycle tank 50 and a second brine stream 25 (recycled brine purge) recycled into the brine regeneration solution tank 16 associated with the softening columns 15. Flow from the brine regeneration solution recycle tank 50 via the brine regeneration solution stream 21 is used to generally continuously regenerate the ammonia polishing columns 31, while flow from the brine regeneration solution tank via stream 26 regenerates the ammonia softening columns 15. This recycled brine is combinable with optional additional brine feed streams 53, 54 flowing into their respective tanks 16, 50 (the additional brine feed may be formed from a water and sodium chloride solution). Even though water is produced when hydroxide reacts with ammonium, some make-up water and salt via the additional brine feed streams 53 or 54 may be needed to replace column clingage losses. The make-up water may be provided as a partial wash. In embodiments, the only ammonium loss is the clingage at the end of a regeneration cycle. In addition to the brine regeneration, a process operation such as continuous purge or periodic replacement of the recirculated brine may be necessary to control potassium buildup.

The brine streams 25 and 52 preferably possess a pH of approximately 10.5 when they exit the ammonia stripper 51. Adjustment of the pH of these streams to neutral may be accomplished if desired, but this pH adjustment is not necessary because the quantity of the hydroxide anion available for reaction with ammonium on a polishing column saturated with ammonium ions is negligible compared to the caustic required to convert those ammonium ions to ammonia.

The ion exchange columns used in both the softening and polishing operations as softening columns 15 and polishing columns 31 may be duplex or triplex so that each column, in the course of normal operation, is capable of being shut down so that maintenance or repair may be performed (or the offline column may be replaced) while the other column(s) of the duplex or triplex is/are in service performing the softening or polishing task. For example, with duplex softening columns 15 shown and described above, after regeneration and conversion of the sodium form to the ammonium form, one of the columns could be idle for approximately 12 hours before the other operating, online column becomes exhausted in softening ability. In contrast, the carbon dioxide removal unit 33 and the ammonia removal unit 35 are designed for continuous operation and must be shut down for repair, replacement, or significant maintenance.

The treated centrate stream 19 exiting from the ammonia polishing columns 31 is sent to pH balance and discharged from the ammonia recovery process or stored, specifically for example sent to the pH balance tank 28 where the pH of the centrate stream 19 is lowered to a value ranging from approximately 6 to approximately 7 and discharged via stream 32. The discharged stream 32 may be returned to the plant (e.g., water plant), re-used, stored, or further treated.

Effluent from the absorption tank 39 which does not flow from the absorption tank 39 as centrate stream 40 exits from the absorption tank as a gas stream 55 (the gas stream 55 may contain carbon dioxide or a mixture of carbon dioxide and air). The gas stream 55 flows outward from the system, for example to a system gas odor scrubber 56 for odor control of the gas. Also entering the gas odor scrubber 56 is a gas stream 57 flowing from the pH-balance tank 28. After odor control is performed on the gases within the gas odor scrubber 56, the odor-controlled stream 58 exits from the ammonia recovery system, either by being re-used in some manner, stored, or vented from the system. Ultimately, the treated centrate streams 55 and 20, after being balanced with the brine stream 27 within the pH balance tank 28 and after the gas 57 is purged from the tank 28, result in treated water stream 32 which may be returned to the plant for re-use, recycled through the ammonia recovery system, stored, or otherwise exit the ammonia recovery system.

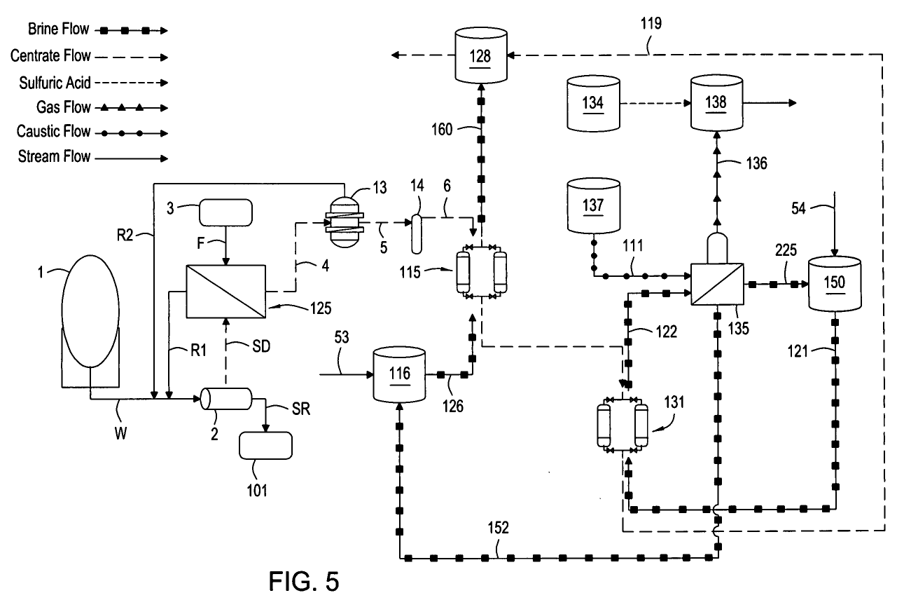

A second embodiment of the ammonia recovery process is depicted in FIG. 5. This embodiment is especially useful when the ammonium ion concentration in the solids-depleted stream SD (the centrate or filtrate stream) is low, preferably where the ammonium ion concentration in the solids-depleted stream SD is less than approximately 500 ppm and more preferably where the ammonium ion concentration is less than approximately 400 ppm.

In the second embodiment, the carbon dioxide removal equipment and the ammonia removal equipment for processing the main centrate stream are eliminated (or at least not operated). The ammonia recovery process is operated with a softening step having an integrated polishing step.

The ammonia recovery process depicted in FIG. 5 is much simpler than the ammonia recovery process of FIG. 3, but the process of FIG. 5 retains the two separate brine systems. The components 1, 2, 101, 125, 3, 13, and 14 and streams W, R2, R1, SD, SR, F, 4, 5, and 6 operate in the same manner and are configured the same as the components of the same number described above in relation to the first embodiment of FIG. 3. The ammonia softening columns 115, ammonia polishing columns 131, ammonia stripper/vacuum unit 135, brine regeneration tank 116, brine regeneration solution recycle tank 150, product tank 138, acid tank 134, caustic tank 137, and pH balance tank 128 (also termed a “return equalization tank”) of the second embodiment shown in FIG. 5 are essentially the same in configuration and operation as the softening columns 15, ammonia polishing columns 31, ammonia stripper/vacuum unit 35, brine regeneration tank 16, brine regeneration solution recycle tank 50, product tank 38, acid tank 34, caustic tank 37, and pH balance tank 28, respectively, described above in relation to FIG. 3, but the ingoing and outgoing streams to and from the above-listed components may be different for each embodiment. Other components present in the first embodiment may be eliminated in the second embodiment, such as the additional vacuum unit/stripper 51, the carbon dioxide absorption tank 39, and/or the carbon dioxide degassing unit 33.

In the second embodiment, a first brine system regenerates the online softening column 115 once it has been exhausted, and this spent brine is discarded from the ammonia polishing system as brine stream 160, for example discarded to the pH balance tank 128 for combination with the polished, treated centrate stream 119 flowed from the ammonia polishing columns 131 to the return equalization tank 128. The first brine system may include a first brine regeneration solution tank 116 from which a brine stream 126 may flow into the online softening column 115. Make-up water and sodium chloride solution 53 may flow into the brine regeneration solution tank 116 to supplement a recycled brine purge 152 flowing from the ammonia stripper 135.

The second brine system regenerates the polishing column(s) 131 once they are loaded with ammonium ions. The second brine system may include a second brine regeneration solution recycle tank 150 from which a brine stream 121 may flow into the ammonia polishing column(s) 131. Make-up water and sodium chloride solution 54 may flow into the brine regeneration solution recycle tank 150 to supplement a recycled brine stream 225 flowing from the ammonia stripper 135. The second brine stream 122 is processed using the ammonia stripper 135 (which may include any stripping device known to those skilled in the art, for example an air or vacuum stripper, although preferably a vacuum stripper), and the treated brine 225 is re-used in the ammonia polishing column(s) 131 (recycling of the brine is evidenced by streams 121, 122, and 225 flowing through the polishing columns 131, ammonia stripper 135, and brine regeneration solution recycle tank 150). The sodium ions from the caustic soda 111 (which may be delivered via the caustic tank 137 to the ammonia stripper 135, and which may optionally include another base instead of caustic soda) replace those lost during the ion exchange process of the polishing column(s) 131.

The benefit of the brine regeneration approach of the second embodiment is that at ammonium ion concentrations of less than 500 ppm, sufficient time exists between the column exhaustions to achieve regeneration of the spent columns. In this case, the equivalents of hardness may be fairly close to the equivalents of ammonia capacity. When this system is employed, it is possible to arrange the columns 115 and 131 in a carousel arrangement, where the hardness removal duty is passed from column to column around the carousel. In an embodiment, an arrangement of four columns may be used, with one column performing softening duty, one column prepared in the ammonium form to take on softening duty in the future, and the other two columns performing ammonium ion recovery duty. When the cycle time between hardness removal regenerations is roughly the same as the cycle time between ammonium ion regenerations, the hardness removed and ammonia recovery regeneration cycles can be performed in tandem.

In a case where the ammonium ion concentration is approximately 400 ppm, where column sizes are the same as in the previous example discussed in paragraph [0048] above, the cycle time for the ammonium ion regenerations are once every 9 hours (an approximate value). This cycle time provides adequate time for regeneration of spent columns 115, 131 for either ammonium ion or hardness removal.

An advantage of the low ammonium ion concentration process of the second embodiment depicted in FIG. 5 is that it avoids the need to eliminate the bicarbonate anion. Instead, the ammonium bicarbonate in the feed stream is converted into sodium bicarbonate in the ion exchange columns 115, 131.

Whether to use the ammonia recovery process of the first embodiment shown in FIG. 3 or of the second embodiment shown in FIG. 5 is primarily driven by the overall economics and local requirements.

With embodiments of the above-described ammonia recovery process, the product ammonium sulfate may be utilized as a commercial grade fertilizer. The nitrogen in the form of ammonia found in the waste stream is thereby efficiently and cost-effectively converted to a usable product by use of the above-described methods and apparatus. The recovery of ammonia in the form of ammonium sulfate or in any other form using the above-described methods and apparatus advantageously limits nitrogen discharge into bodies of water, as often required by environmental regulations, along with providing a usable end-product (e.g., ammonium sulfate). The ammonium sulfate (or other formed product) is capable of being crystallized to form a pure product.

In alternate embodiments (not shown), flow switching based on conductivity may be utilized in the above-described ammonia recovery process. Although the brine discussed above may include any relative concentrations of sodium chloride and water in embodiments of the present invention, the brine may optionally include, for example, approximately 10% sodium chloride.

A further alternate embodiment involves using an anion resin to remove the bicarbonate during the cation softening step. Upon anaerobic digestion, more bicarbonate than hardness will exist in the stream, creating a mismatch. Via the ion exchange of the softening step, the brine may be used to remove both the bicarbonate and the hardness, and the acid addition step to remove the carbon dioxide may optionally be bypassed. Enough brine may be provided to remove the bicarbonate and to re-use this brine to also remove the hardness. Another embodiment entails taking out the extra bicarbonate and placing it through acid treatment.

Ion exchange and the ion exchange process is shown and described in “Ion Exchange Primer,” pages 1-12, distributed by Sybron Chemicals, Inc., which is herein incorporated by reference in its entirety. Any of the ion exchange principles, resins, equipment, and operations described in the “Ion Exchange Primer” may be utilized in any of the above embodiments. In any of the above embodiments, the brine may be substituted with sodium hydroxide, sodium chloride, brine, or a combination or solution thereof.

While the foregoing is directed to embodiments of the present invention, other and further embodiments of the invention may be devised without departing from the basic scope thereof, and the scope thereof is determined by the claims that follow.

1. A method for removing ammonia from a stream, the stream comprising therein soluble ammonia, ammonium ions, or a combination thereof and carbonate anions, bicarbonate anions, or a combination thereof, the method comprising:
(1) reducing suspended solids from the stream by flotation, settling, or filtration;
(2) removing divalent and trivalent cations from the stream via ion exchange;
(3) converting any carbonate anions, bicarbonate anions, or the combination thereof in the stream to carbon dioxide by adding an effective amount of one or more acids;
(4) removing the carbon dioxide from the stream using one or more mass transfer devices;
(5) converting the ammonium ions to ammonia by adding an effective amount of one or more bases; and
(6) removing ammonia from the stream by converting the ammonia into a gaseous form and absorbing the gaseous ammonia into a separate solution.

2. The method of claim 1, further comprising:
(7) converting the ammonia remaining in the stream after step (6) to ammonium cations by contacting the stream with the carbon dioxide removed in step 4 or by adding one or more mineral acids to the stream.

3. The method of claim 2, further comprising:
(8) after step (7), absorbing any remaining ammonium ions in the stream onto an ion exchange resin.

4. The method of claim 3, wherein the ion exchange resin is a sodium form ion exchange resin.

5. The method of claim 3, further comprising:
(9) regenerating the ion exchange resin to form a high-ammonia spent solution.

6. The method of claim 5, wherein the ion exchange resin is a sodium form ion exchange resin and is regenerated with a sodium chloride brine to form a high ammonia spent brine solution.

7. The method of claim 5, further comprising:
(10) converting any ammonium cations in the high-ammonia spent solution to ammonia by addition of one or more bases; and
(11) recovering the ammonia from the spent solution by converting the ammonia into a gaseous form and absorbing the gaseous ammonia into the separate solution.

8. The method of claim 7, further comprising:
(12) re-using the spent solution after removing a bulk of the ammonia.

9. The method of claim 5, wherein one or more softening columns perform the ion exchange.

10. The method of claim 9, further comprising:
after step (9), using at least a portion of a partially-treated stream resulting after step (7) to convert the one or more softening columns having the regenerated ion exchange resin to an ammonium form.

11. The method of claim 1, wherein prior to step (1), the stream comprises approximately 500 parts per million or more of the soluble ammonia, ammonium ions, or a combination thereof.

12. The method of claim 1, wherein prior to step (1), the stream comprises approximately 900 parts per million or more of the soluble ammonia, ammonium ions, or a combination thereof.

13. The method of claim 1, wherein prior to step (1), the stream further comprises hardness and bicarbonate anions therein.

14. The method of claim 1, wherein the one or more acids comprise sulfuric acid.

15. The method of claim 1, wherein the one or more bases comprise sodium hydroxide.

16. The method of claim 1, wherein the one or more mass transfer devices of step (4) comprise one or more packed columns, one or more gas strippers, or a combination thereof.

17. The method of claim 1, wherein the separate solution of step (6) comprises one or more mineral acids.

18. A method for removing ammonia from a stream, the stream comprising therein soluble ammonia, ammonium ions, or a combination thereof and carbonate, comprising:
(1) reducing suspended solids from the stream by flotation, settling, or filtration;
(2) removing divalent and trivalent cations from the stream via ion exchange;
(3) absorbing any remaining ammonium ions in the stream onto an ion exchange resin;
(4) regenerating the ion exchange resin to form a high-ammonia spent solution;
(5) converting any ammonium cations in the high-ammonia spent solution to ammonia by addition of one or more bases; and
(6) recovering the ammonia from the spent solution by converting the ammonia into a gaseous form and absorbing the gaseous ammonia into a separate solution.

19. The method of claim 18, further comprising:
(7) re-using the spent solution after removing a bulk of the ammonia.

20. The method of claim 18, wherein prior to step (1), the stream comprises approximately 900 parts per million or less of the soluble ammonia, ammonium ions, or a combination thereof.

21. The method of claim 18, wherein prior to step (1), the stream comprises approximately 400 parts per million or less of the soluble ammonia, ammonium ions, or a combination thereof.

22. The method of claim 18, wherein the ion exchange resin is a sodium form ion exchange resin.

23. The method of claim 22, wherein the regenerating the ion exchange resin to form a high-ammonia spent solution of step (4) comprises regenerating the ion exchange resin with a sodium chloride brine to form a high-ammonia spent brine solution.

24. The method of claim 18, wherein the one or more bases comprise sodium hydroxide.

25. The method of claim 18, wherein the separate solution comprises one or more mineral acids.

26. A method for removing ammonia from a waste stream, the waste stream comprising therein soluble ammonia, ammonium ions, or a combination thereof and carbonate anions, bicarbonate anions, or a combination thereof, the method comprising:
(1) reducing suspended solids from the waste stream by flotation, settling, or filtration;
(2) removing divalent and trivalent cations from the waste stream via ion exchange using one or more ion exchange softening columns;
(3) diverting flow of the waste stream from a carbon dioxide stripping column and an ammonia stripping column disposed downstream from the one or more ion exchange softening columns;
(4) using the waste stream to convert one or more freshly regenerated ion exchange softening columns to ammonium form; and
(5) returning the one or more ion exchange softening columns to ion exchange service.

27. The method of claim 26, further comprising:
(6) using the waste stream to convert one or more freshly regenerated ion exchange polishing columns to ammonium form; and
(7) returning the one or more ion exchange polishing columns to ion exchange service.

28. A method for removing ammonia from a stream, the stream comprising therein soluble ammonia, ammonium ions, or a combination thereof and carbonate anions, bicarbonate anions, or a combination thereof, the method comprising:
(1) reducing suspended solids from the stream by flotation, settling, or filtration;
(2) removing divalent and trivalent cations from the stream via ion exchange;
(3) removing the bicarbonate anions from the stream via ion exchange;
(4) if any carbon dioxide is present in the stream, removing the carbon dioxide from the stream using one or more mass transfer devices;
(5) converting the ammonium ions to ammonia by adding an effective amount of one or more bases; and
(6) removing ammonia from the stream by converting the ammonia into a gaseous form and absorbing the gaseous ammonia into a separate solution.

29. The method of claim 28, further comprising after step (3), converting any carbonate anions, bicarbonate anions, or the combination thereof in the stream to carbon dioxide by adding an effective amount of one or more acids.

30. The method of claim 28, further comprising removing hardness from the stream via ion exchange during step (3).

31. The method of claim 28, wherein the ion exchange of step (3) comprises using an anion resin to remove the bicarbonate anions from the stream.
